(19) United States
(12) Patent Application Publication
(10) Pub. No.: US 2016/0101015 A1
(43) Pub. Date: Apr. 14, 2016

(54) Compression System With Vent Cooling Feature

(71) Applicant: Covidien LP, Mansfield, MA (US)

(72) Inventor: Arnaz Malhi, Watertown, MA (US)

(21) Appl. No.: 14/955,421

(22) Filed: Dec. 1, 2015

Related U.S. Application Data
(63) Continuation of application No. 13/525,412, filed on Jun. 18, 2012, now Pat. No. 9,205,021.

(51) Int. Cl. A61H 9/00

(52) U.S. Cl. CPC A61H 9/0078; A61H 2201/0214; A61H 2205/106

(57) ABSTRACT

A compression device for providing compression treatment to a limb of a wearer includes a compression garment positionable on the limb of the wearer. The garment includes an inflatable bladder for providing compression treatment to the limb. A controller is adapted for fluidly connecting to the inflatable bladder and configured for inflating and deflating the bladder during a compression cycle. The controller has an exhaust port positioned to direct exhaust fluid through the bladder so exhaust fluid flows over the limb of the wearer to cool the limb.

### CROSS-REFERENCE TO RELATED APPLICATION

This application is a continuation application of U.S. patent application Ser. No. 13/525,412, filed Jun. 18, 2012, the entirety of which is incorporated herein by reference.

### FIELD OF THE INVENTION

The present invention generally relates to a compression device for applying compression therapy to a body part of a wearer.

### BACKGROUND OF THE INVENTION

Generally, intermittent pneumatic compression (IPC) systems for deep vein thrombosis (DVT) prophylaxis consist of a controller having a pump and associated control electronics, a compression sleeve (e.g., a sequential compression sleeve) which is applied to the patient's body part, and tubing sets that communicate between the pump and the sleeve.

Sequential compression sleeves are typically constructed of two sheets of fluid impermeable material joined at seams to define one or more fluid impervious bladders. The tubing connects the bladders to the pump for inflating the bladders to apply compressive pressure around the patient's body parts. Typically, the controller is programmed to perform cyclic compression by pumping air into the bladders of the sleeve during a compression segment of the cycle followed by exhausting air from the bladders during a deflation segment of the cycle. The air exhausts through one or more exhaust ports associated with the controller (see Prior Art FIGS. 1 and 2). The exhaust ports usually vent to atmosphere around the patient, deflating the sleeve to enable blood to reenter the veins.

The bladders may be covered with a laminate to improve durability and protect against puncture. The impermeability of the sleeve can trap moisture (i.e., perspiration) between the bladder sheets and the patient's body, causing some discomfort. Discomfort can lead to the patient's unwillingness to wear the sleeve, potentially endangering the patient's health.

An advancement in this field has been to place the controller directly on the sleeve, eliminating the need for long and unwieldy tubing sets. These systems, though portable, do not address the issues of moisture build-up that can occur with conventional compression sleeves.

The present invention provides an improved arrangement for reducing moisture build-up and improving patient compliance.

### SUMMARY OF THE INVENTION

In one aspect, the present invention includes a compression device for providing compression treatment to a limb of a wearer. The device comprises a compression garment positionable on the limb of the wearer. The garment comprises an inflatable bladder for providing compression treatment to a compression region of the limb. The device also includes a controller fluidly connected to the inflatable bladder and configured for inflating and deflating the bladder during a compression cycle. The controller includes an exhaust port positioned to direct exhaust fluid toward the compression region as the bladder deflates so exhaust fluid flows over the limb of the wearer to cool the limb.

In another aspect, the invention includes a method of providing compression treatment to a limb of a wearer using a compression device including an inflatable bladder positioned on the limb of the wearer and a controller fluidly connected to the inflatable bladder. The method comprises pressurizing the inflatable bladder with pressurized fluid from the controller to inflate the bladder and compress a compression region of the limb. Further, the inflatable bladder is depressurized by venting the pressurized fluid out of the inflatable bladder. The method includes exhausting the vented fluid out of the controller through an exhaust port in the controller and directing the vented fluid toward the compression region of the limb to cool the limb.

In still another aspect, the present invention includes a compression device for providing compression treatment to a limb of a wearer. The device comprises a compression garment positionable on the limb of the wearer. The garment comprises an inflatable bladder for providing compression treatment to a compression region of the limb. The garment has an opening and a controller fluidly connected to the inflatable bladder and configured for inflating and deflating the bladder during a compression cycle. The controller includes an exhaust port positioned to direct exhaust fluid through the opening in the garment and to direct the exhaust fluid toward the compression region as the bladder deflates so exhaust fluid flows over the limb of the wearer to cool the limb. The device also includes a guide attached to the bladder around the opening for guiding fluid directed to the opening to flow over the limb of the wearer.

Other objects and features will be in part apparent and in part pointed out hereinafter.

### BRIEF DESCRIPTION OF THE DRAWINGS

FIG. 1 is a schematic of a first configuration of a prior art compression device;

FIG. 2 is a schematic of a second configuration of a prior art compression device;

FIG. 3 is a perspective of a compression device of the present invention secured to a leg of a wearer;

FIG. 4 is a front elevation of a compression sleeve of the compression device with an outer cover and intermediate layers of the sleeve partially removed to show underlying layers;

FIG. 5 is an enlarged fragmentary elevation of the outer cover illustrating loop material;

FIG. 6 is a perspective view of a controller of the compression device;

FIG. 7 is a rear view of the controller;

FIG. 8 is an enlarged fragmentary section showing an exhaust port in the controller in registration with an opening in the sleeve;

FIG. 9 is a schematic of a second embodiment of a compression device of the present invention; and

FIG. 10 is an enlarged fragmentary elevation of an inner surface of a first intermediate layer of the compression sleeve.

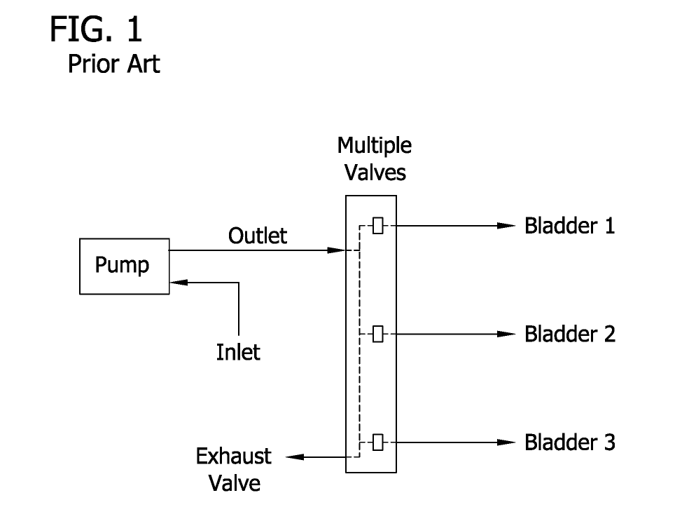

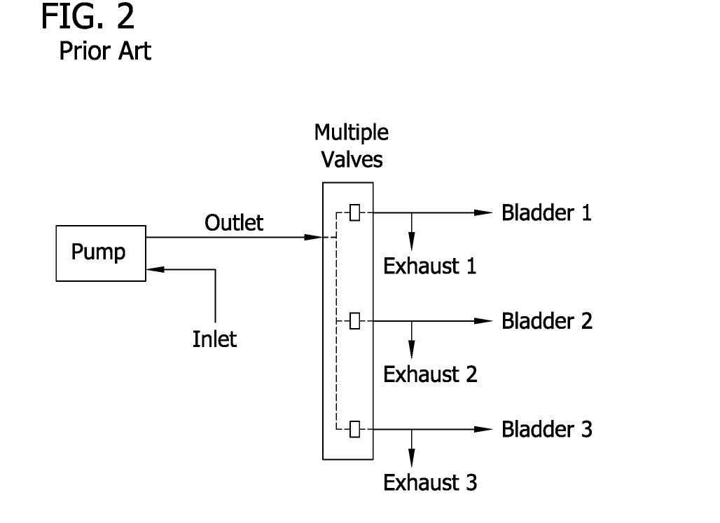

Corresponding reference characters indicate corresponding parts throughout the drawings.

### DESCRIPTION OF THE PREFERRED EMBODIMENTS

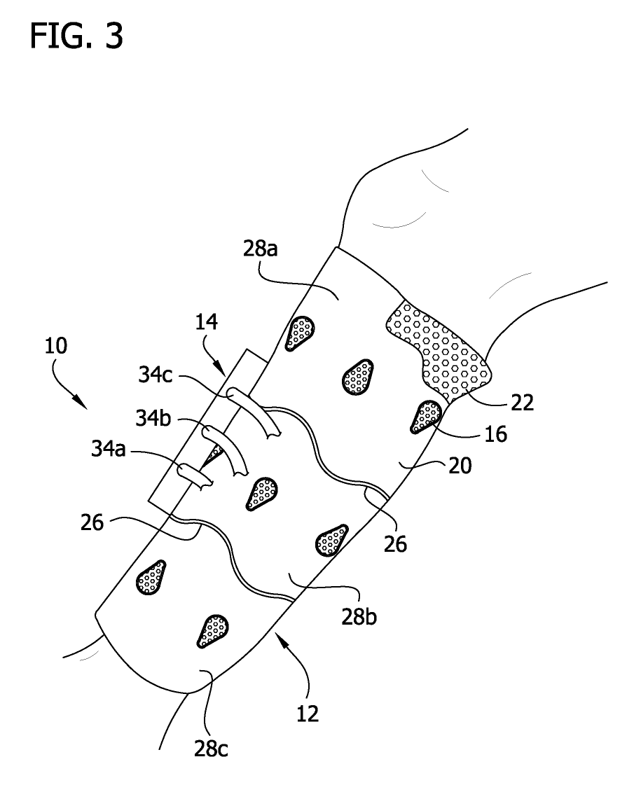

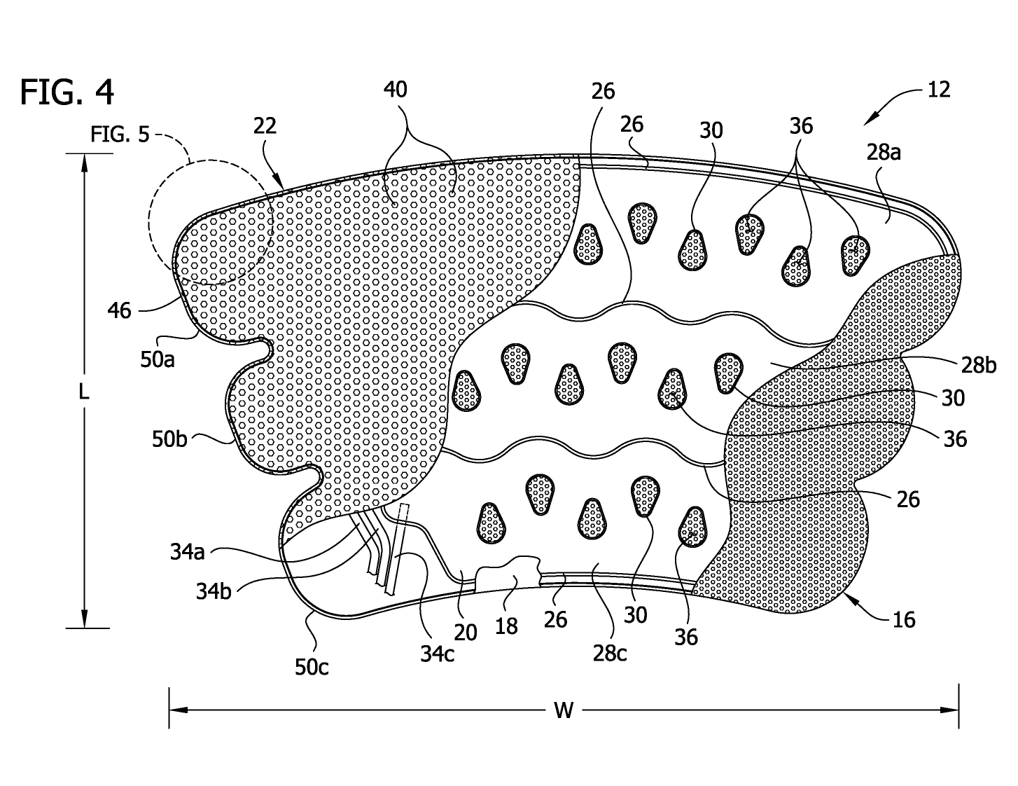

Referring now to the drawings and in particular to FIGS. 3 and 4, a compression device for applying cyclical compression therapy to a limb (e.g., a leg) of a wearer is indicated in its entirety by the reference number 10. The compression device 10 comprises a compression sleeve 12 and a controller 14 (or “air compressor unit”) directly attached to the compression sleeve for supplying pressurized fluid to the sleeve 12 for providing compression therapy to the limb. The compression device 10 has a portable configuration such that the wearer of the device can more easily move about while wearing the device. However, the controller 14 may have a configuration other than portable such that the controller is not directly attached to the sleeve 12 without departing from the scope of the invention.

The compression sleeve 12 is of the type sized and shaped for being disposed around a leg of the wearer, but could be configured to be applied to other parts of the wearer's body. More specifically, the sleeve 12 has a width W (FIG. 4) for being wrapped around a full circumference of the leg and a length L for running from the ankle to a knee of the leg. This type of sleeve is generally referred to in the art as a knee-length sleeve. It will be understood that a compression sleeve may come in different sizes, such as a thigh-length sleeve (not shown) extending from the ankle to the thigh of the leg. It is understood that compression devices having other configurations for being disposed about other parts of the wearer's body, are also within the scope of this invention, such as a wrap around a patient's chest in the treatment of breast cancer.

Referring to FIG. 4, the compression sleeve 10 may comprise four layers secured together. The scope of the present invention, however, is not limited to four layers (FIG. 3 shows the compression sleeve 12 having only two layers.) In the illustrated embodiment, the compression sleeve 10 comprises an inner layer, generally indicated by 16, on which a first intermediate layer (broadly, a first bladder layer), generally indicated by 18, is overlaid. A second intermediate layer (broadly, a second bladder layer), generally indicated by 20, overlies the first intermediate layer 18 and is secured thereto. An outer cover generally indicated by 22, overlies and is secured to the second intermediate layer 20. In use, the inner layer 16 will contact the limb of the wearer, and the outer cover 22 will be farthest from the limb of the wearer. If the sleeve 12 is constructed using only two layers of material (e.g., two bladder layers 18, 20), then the first bladder layer 18 will contact the limb of the wearer, and the second bladder layer 20 will be farther from the limb of the wearer (see FIG. 3).

The layers have the same shape and are superposed on each other so edges of the layers generally coincide. It is contemplated that one or more of the layers 16, 18, 20, or 22 may not be superposed on a corresponding layer, but slightly offset to accommodate a particular feature of a patient's limb. Moreover, the number of sheets making up the compression sleeve 12 may be other than described.

The first and second intermediate layers 18, 20, respectively, each include a single sheet of elastic material (broadly, “bladder material”). For example, the sheets 18 and 20 are made of a pliable PVC material having a thickness of about 0.006 inch. The inner and outer layers 16 and 22 can be made of a polyester material having a thickness of about 0.005 inch. The materials and thicknesses of the layers may vary to add strength or to cause more expansion in one direction, such as toward the limb, during inflation. The second intermediate layer 20 may be secured to the first intermediate layer 18 along bladder seam lines 26 defining a proximal bladder 28a, an intermediate bladder 28b and a distal bladder 28c, respectively, that are spaced longitudinally along the length L of the sleeve 12. The number of bladders may be other than three without departing from the scope of the present invention. As used herein, the terms “proximal”, “distal”, and “intermediate” represent relative locations of components, parts and the like of the compression sleeve when the sleeve is secured to the wearer's limb. As such, a “proximal” component or the like is disposed most adjacent to a point of attachment of the wearer's limb to the wearer's torso, a “distal” component is disposed most distant from the point of attachment, and an “intermediate” component is disposed generally anywhere between the proximal and distal components.

The bladders 28a, 28b, 28c are circumferential bladders meaning that they are sized and shaped to wrap around the wearer's limb or around very nearly the entire circumference of the limb. For example, in one embodiment, the bladders 28a, 28b, 28c each extend around at least 90% around a leg. It is to be understood that the construction described herein can be adopted by the prior art sleeves with a partial bladder construction, without departing from the scope of the present invention.

The intermediate layers 18, 20 may be secured together by radiofrequency (RF) welding, adhesive, or other chemical and/or mechanical process. Further, the intermediate layers 18, 20 may be secured together at other locations, such as around their peripheries or at the bladder seam lines 26 to further define the shape of the inflatable bladders 28a, 28b, 28c. The first intermediate layer 18 may be secured to the inner layer 16 along a seam line 46 extending along the outer periphery of the first intermediate layer 18 so central regions of the bladders 28a, 28b, 28c are not secured to the inner layer 16 permitting the bladders to move relative to the inner layer 16. The second intermediate layer 20 may also be secured to the inner layer 12 along the same seam line 46. The first intermediate layer 18 may be secured to the inner layer 16 by RF welding, adhesive, or in other suitable ways.

Referring to FIG. 4, each inflatable bladder 28a, 28b, 28c receives fluid from the controller 14 mounted on the sleeve 12 via a dedicated proximal bladder tube 34a, intermediate bladder tube 34b, and distal bladder tube 34c, respectively, fluidly connecting the bladders to the controller. As will be appreciated, a tube line need not be dedicated to a bladder to practice the invention. In one embodiment, the bladders 28a, 28b, 28c are configured to hold air pressurized in a range of about 10 mm Hg (1333 Pa) to about 45 mm Hg (6000 Pa). Further, the bladders 28a, 28b, 28c are preferably capable of being repeatedly pressurized without failure. Materials suitable for the sheets include, but are not limited to, flexible PVC material that will not stretch substantially. In another embodiment, the intermediate layers 18, 20 may form a chamber for receiving an inflatable bladder that is formed separate from the chamber. In this embodiment, the layers 18, 20 need not be capable of containing pressurized air provided the inflatable bladders are. As will be appreciated by those skilled in the art, the bladders 28a, 28b, 28c may have openings 36 extending completely through the bladders. Further, these opening 36 may be formed by a seam line 30 sealing the bladder layers 18, 20 together. In the illustrated embodiment, the openings 36 are tear-drop-shaped, but the openings may have other shapes without departing from the scope of the invention.

The inner layer 16 may be constructed of a material that is capable of wicking moisture. The inner (or “wicking”) layer 16, through capillary action, absorbs moisture trapped near the limb of the wearer, carries the moisture away from the surface of the limb, and transports the moisture from locations on the limb at the inner layer 16 where the moisture is abundant to areas where it is less abundant (e.g., closer to the openings 36 in the bladders 28a, 28b, 28c), to evaporate to the ambient environment. The openings 36 may have various sizes, shapes, and locations within the area of the bladder providing the compression. Each opening 36 may expose the wicking layer 16 to the ambient air as opposed to the portion of the wicking layer beneath the bladder material. The portions of the inner layer 16 in registration with the openings 36 may be referred to as “exposed portions”. Other ways of exposing the wicking material such as slits or extending the wicking material outside the perimeter of the bladder material are also envisioned as being within the scope of the present invention. If the sleeve 12 is constructed having only two bladder layers 18, 20, then the openings 36 expose portions of the limb of the wearer to the atmosphere.

In the illustrated embodiment, the bladders 28a, 28b, 28c have openings 36. Thus, the regions of the sleeve 12 that expand and contract under the influence of air pressure or other fluids to provide compression have the openings 36. The regions of the sleeve 12 that do not provide compression (e.g., the seam lines 26) do not have openings 36. The wicking material 16 may be inter-weaved with the impervious material to form the inner layer 16 that transports moisture to an area of less moisture. The openings 36 must be sized, shaped, and positioned so the sleeve provides adequate compression to maintain blood velocity, while maximizing evaporation of moisture. Suitable wicking materials may comprise, for example, some forms of polyester and/or polypropylene. Microfibers may be used. Suitable microfiber materials include, but are not limited to, CoolDry model number CD9604, sold by Quanzhou Fulian Warp Knitting Industrial Co., Ltd. of Quanzhou City, Fujian Province, China, and CoolMax®, sold by E. I. duPont de Nemours and Company of Wilmington, Del.

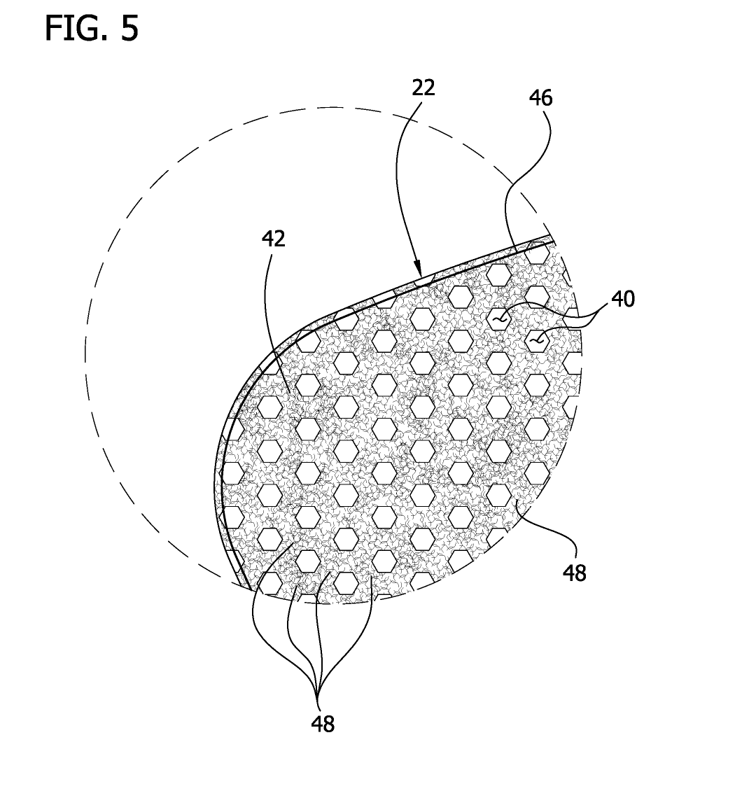

Referring to FIGS. 4 and 5, the outer cover 22 of the compression sleeve 12 may be constructed of a single sheet of material. In the embodiment, the outer cover 22 is breathable and has a multiplicity of openings 40 or perforations so it has a mesh construction to provide even more breathability. A suitable material for the outer cover 22 may be a polyester mesh. The rate of evaporation through the openings is improved by treating the fibers of the mesh material with a hydrophilic material, so the mesh material absorbs the wicked fluid more readily. Wicking fibers of this type are indicated generally by 42 in FIG. 5. These hydrophilic fibers 42 lower the surface tension of the mesh material to allow bodily fluids to more easily absorb into the fibers and spread through the material to provide more efficient evaporation of the wicked fluid. Absorbing fluid more readily allows the fluid to move to the open areas more quickly for evaporation. The capillary effect is made more efficient when the absorbed fluid from the openings moves more quickly through the mesh outer cover 22.

The entire outer surface of the outer cover 22 may act as a fastening component of a fastening system for securing the sleeve 12 to the limb of the wearer. In a particular embodiment, the outer cover 22 of mesh (FIG. 5) has an outer surface comprising loops 48, that act as a loop component of a hook-and-loop fastening system. A mesh construction, as shown in FIG. 5, may have interconnected or weaved fibers 42 of material forming the outer cover 22. The loops 48 may be formed as part of the material of the outer cover 22 or otherwise disposed on the surface of the outer cover. A suitable material with such construction is a polyester mesh loop 2103 sold by Quanzhou Fulian Warp Knitting Industrial Co., Ltd. of Quanzhou City, China. Hook components (not shown) may be attached to an inner surface of the inner layer 16 at proximal, intermediate and distal flaps 50a, 50b, 50c, respectively (FIG. 4). The loops 48 of the outer cover 22 allow the hook components to be secured anywhere along the outer surface of the outer cover 22 when the sleeve 12 is wrapped circumferentially around the limb of the wearer. This allows the sleeve 12 to be of a substantially one-size-fits-all configuration with respect to the circumferences of different wearers' limbs. Moreover, the loops 48 on the outer cover 22 allow the practitioner to quickly and confidently secure the sleeve 12 to the wearer's limb without needing to align the fastening components.

It is contemplated that the outer cover 22 may be capable of wicking fluid in addition to being breathable. For example, the outer cover 22 may be constructed of the same material as the inner layer 16 (e.g., Cool dry). In this way, the moisture wicked by the inner layer 16 may be wicked by the outer cover 22 through the openings 36 in the bladders 28a, 28b, 28c. The moisture can spread out evenly across the outer cover 22 and is able to evaporate more readily than if the outer cover was not formed of a wicking material because a greater surface area of the outer cover, as opposed to the inner layer 16, is exposed to air. Alternatively, the cover 22 can have a wicking material laced in or on top of outer layer.

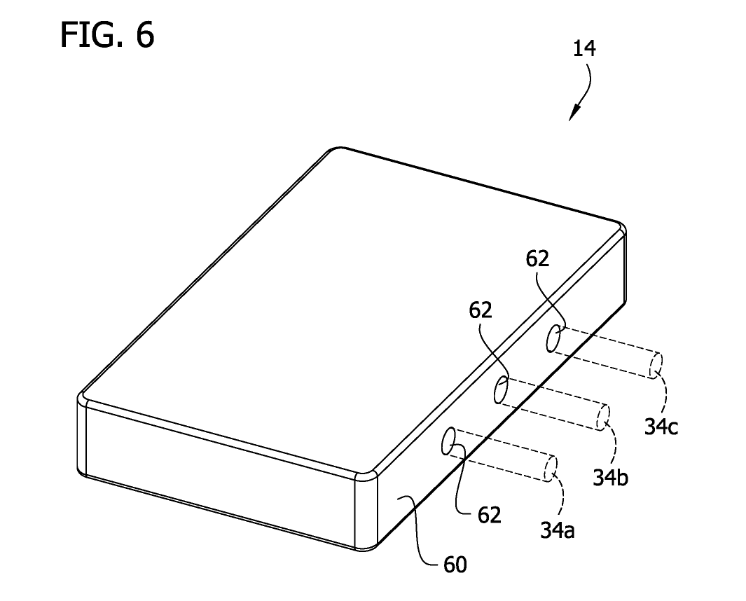

Referring to FIGS. 6-9, the controller 14 comprises a housing 60 enclosing the necessary components for pressurizing the bladders 28a, 28b, 28c. The controller 14 may be programmed to execute various compression regimens, which may include inflation and deflation (vent) phases. A configuration in which a controller 14 is removably mounted on a compression garment and operatively connected to bladders on the compression garment is disclosed in more detail in U.S. patent application Ser. Nos. 12/241,670, 12/241,936, and 12/893,679 which are assigned to Tyco Healthcare Group LP and incorporated by reference in their entireties. Other embodiments where the controller 14 is not configured for mounting directly on the sleeve 12 are also within the scope of the present invention.

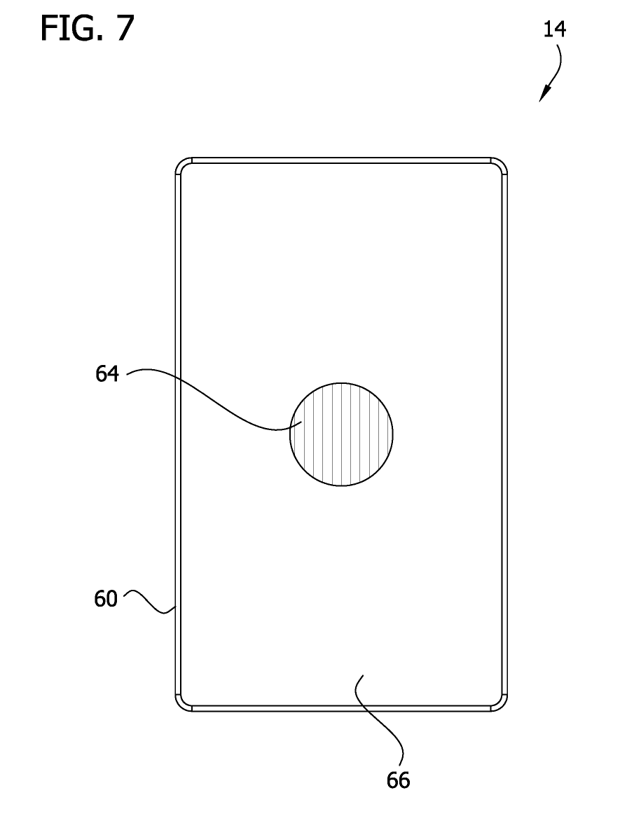

Supply ports 62 in the controller housing 60 are configured to attach the bladder tubes 34a-c to the controller 14 for delivering pressurized fluid to the inflatable bladders 28a-c. An exhaust port 64 (FIG. 7) is disposed in a back 66 of the controller housing 60 for expelling the vented pressurized fluid from the compression device 10 during the vent phase. In the illustrated embodiment, a single exhaust port 64 is shown. However, the controller 14 may also have a plurality of exhaust ports without departing from the scope of the invention.

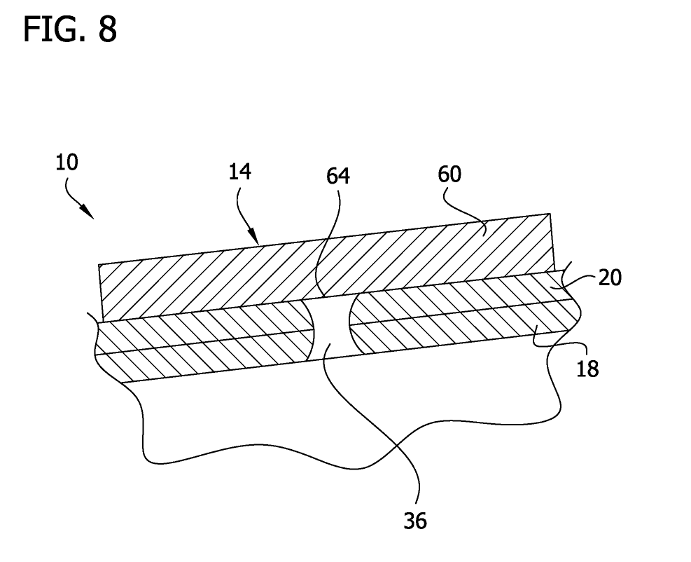

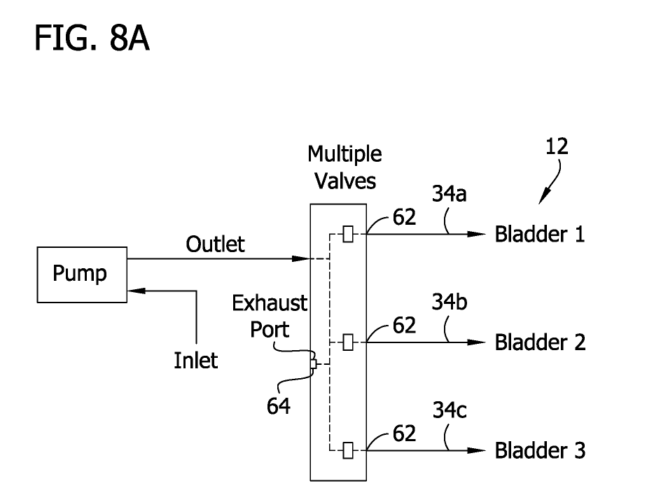

Referring to FIGS. 3 and 8, the controller 14 is mounted on the sleeve 12 such that the exhaust port 64 faces an outer surface of the sleeve (e.g., outer cover 22 or second intermediate layer 20). Therefore, during the vent phase, the exhausted fluid is not expelled into ambient as is the case with prior art designs. Instead, the vented fluid is directed onto the sleeve 12. The vented air will flow past the outer cover, bladder layers and inner layer, and flow over the leg of the wearer providing a cooling effect to the leg and improving moisture evaporation, because the outer cover 22 is formed of a mesh material, because the bladder layers 18, 20 have openings 36, and because the inner layer 16 is gas permeable. In the illustrated embodiment, the exhaust port 64 is located in a calf area of the leg. Typically, the calf area is the location where a larger percentage of moisture accumulates during compression treatment. The exhaust port 64 could be located in a different area of the leg without departing from the scope of the present invention.

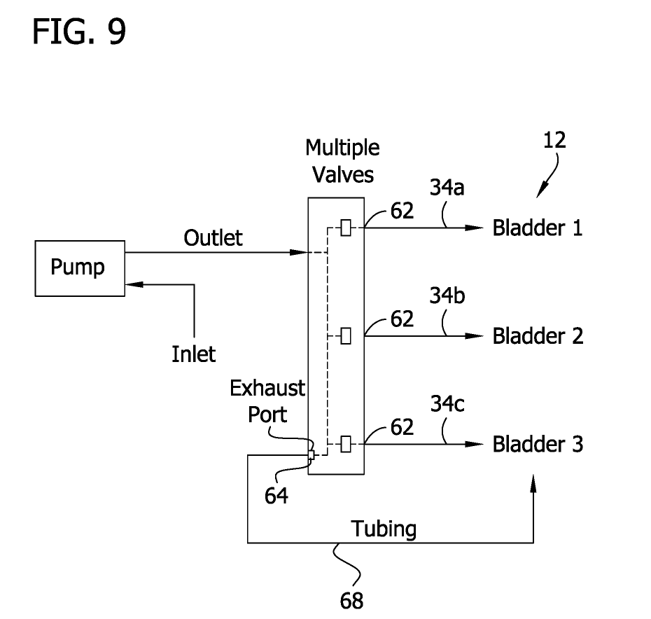

Referring to FIG. 8, the exhaust port 64 may be positioned directly over an opening 36 in the bladder layers 18, 20 to increase the amount of air that impinges upon the leg. When the controller 14 includes multiple exhaust ports 64, they can be generally aligned with an opening 36. If the compression device is configured so that the controller is not mounted directly on the sleeve, an exhaust port of the controller can be in fluid communication with an exterior surface of the sleeve through tubing 68 (FIG. 9) extending from the exhaust port 64 to the sleeve 12. The tubing can be positioned such that the vented air is directed through an opening 36 in the bladder layers 18, 20 (FIG. 4).

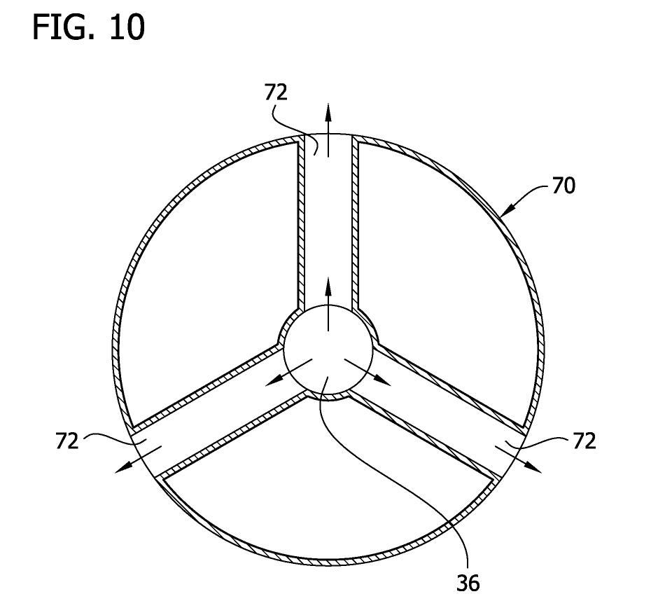

Referring to FIG. 10, fluid impermeable sheets 60 (e.g., plastic sheets) can be welded (e.g., by RF welding) around the openings 36 that receive the vented fluid. In FIG. 10 the opening 36 is circular, but can also be teardrop-shaped as shown in FIGS. 3 and 4. The sheets 60 can be welded to an inner surface of the first intermediate layer 18 and around the opening 36 as shown to form three fluid channels 62 for directing fluid entering the opening 36 away from the opening. The channels 62 guide the air to facilitate the cooling of areas of the wearer's skin that are not directly below the opening 36. For example, it is envisioned that the channels 62 can be formed to guide air toward a back of the wear's calf where more perspiration may be present. Although the sheet 60 is welded to form three channels 62 in the illustrated embodiment, those skilled in the art will appreciate that fewer or more channels may be formed or the sheets may be embossed with dimples to provide multiple airways. As will also be appreciated, the sheet-and-channel configuration may be broadly referred to as a guide.

Having described the invention in detail, it will be apparent that modifications and variations are possible without departing from the scope of the invention defined in the appended claims.

When introducing elements of the present invention or the preferred embodiments(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

1-20. (canceled)

21. A compression device for providing compression treatment to a limb of a wearer, the compression device comprising:
a compression garment positionable on the limb of the wearer, the compression garment comprising a plurality of inflatable bladders defining a compression region; and
a controller directly attached to the compression garment, the controller fluidly connected to each bladder of the plurality of inflatable bladders and configured for inflating and deflating the bladder during a compression cycle, and the controller including an exhaust port positioned to direct exhaust fluid toward the limb of the wearer in the compression region when the compression garment is worn.

22. The compression device of claim 21, wherein the controller is directly attached to the compression garment along the compression region.

23. The compression device of claim 21, wherein the controller is in fluid communication with each bladder of the plurality of inflatable bladders via a respective, separate bladder tube.

24. The compression device of claim 21, wherein each bladder of the plurality of bladders defines an opening extending through the respective bladder.

25. The compression device of claim 24, wherein the opening extending through each respective bladder is defined by a seam line of the respective bladder.

26. The compression device of claim 24, wherein the exhaust port is positioned to direct the exhaust fluid through one of the openings.

27. The compression device of claim 21, wherein the exhaust port is located along a portion of the compression garment in a calf area when the compression garment is positioned on a leg of the wearer.

28. The compression device of claim 21, wherein the compression garment further comprises a wicking layer contacting the limb of the wearer when the compression garment is worn, the exhaust port positioned to direct exhaust fluid toward the wicking layer.

29. The compression device of claim 28, wherein the wicking layer extends outside of a perimeter of the plurality of inflatable bladders.
